(19) United States
(12) Patent Application Publication
(10) Pub. No.: US 2025/0009158 A1
(43) Pub. Date: Jan. 9, 2025

(54) FLOORING PRODUCT HAVING A POLYESTER-BASED COATED FACE FIBER

(71) Applicant: ALADDIN MANUFACTURING CORPORATION, Calhoun, GA (US)

(72) Inventors: Erika MORENO, Calhoun, GA (US); Harlan MORRIS, Calhoun, GA (US); Michael GEARHART, Calhoun, GA (US); Carlos CARRILLO, Calhoun, GA (US); Martin SHAMIS, Cartersville, GA (US)

(21) Appl. No.: 18/708,706

(22) PCT Filed: Nov. 3, 2022
(86) PCT No.: PCT/IB2022/060591

§ 371 Date: May 9, 2024

Related U.S. Application Data
(60) Provisional application No. 63/279,803, filed on Nov. 16, 2021.

(51) Int. Cl. A47G 27/02; B32B 5/02; B32B 5/26; B32B 27/08; B32B 27/12; B32B 37/12; B32B 37/24

(52) U.S. Cl. CPC A47G 27/02; B32B 5/022; B32B 5/024; B32B 5/26; B32B 27/08; B32B 27/12; B32B 37/12; B32B 37/24; B32B 2037/243; B32B 2255/02; B32B 2255/26; B32B 2307/554; B32B 2307/7265

(57) ABSTRACT

The present disclosure provides for a flooring product comprising a primary backing having a face side and a back side; a plurality of fibers tufted into the primary backing and extending from the face side to form a face fiber having a predetermined length, and a layer of a polyester-based material disposed at at least a portion of the face fiber, where the layer of the polyester-based material can at least partially encapsulate at least some of the plurality of fibers.

### TECHNICAL FIELD

This disclosure relates to flooring products having a polyester-based material disposed at at least a portion of a face fiber. The disclosure also relates to flooring products where the polyester-based material at least partially incorporates at least a portion of the plurality of fibers present in the face fiber. Methods of making the same are also disclosed.

### BACKGROUND

Within the textile industry, and particularly the carpet industry, consumers increasingly demand products that have more robust characteristics and properties. Generally, carpets are produced by tufting a plurality of fibers into the primary backing, and thus forming a face fiber of the carpet.

Carpets are one of the most popular products used both in commercial and residential constructions. Carpets are often subjected to heavy foot traffic and require frequent cleaning to ensure a healthy and hygienic environment. However, heavy foot traffic and frequent cleaning can affect the quality of the face fiber and the general appearance of the carpet.

As carpets are usually long-term capital investments. The carpet needs to possess various durability properties, including high wear and abrasion resistance. However, it is also important to produce such high wear and abrasion-resistant carpets without increasing the cost or environmental impact or without affecting the esthetic appearance of the carpet.

Thus, there is a clear need for novel flooring products that can withstand high foot traffic, frequent and harsh cleaning and still provide cradle-to-cradle or cradle-to-grave environmentally conscious solutions. Still, further, there is a need for methods of manufacturing such products. These needs and other needs are at least partially satisfied by the present disclosure.

### SUMMARY

The present disclosure is directed to a flooring product comprising: a) a primary backing having a face side and a back side; b) a plurality of fibers tufted into the primary backing and extending from the face side to form a face fiber having a predetermined length; and c) a layer of a polyester-based material disposed at at least a portion of the face fiber.

In still further aspects, the layer of the polyester-based material is present as a continuous film. While in other aspects, the layer of the polyester-based material is present as a discontinuous film. In still further aspects, the layer of a polyester-based material can at least partially encapsulate at least a portion of the plurality of fibers.

In the aspects disclosed herein, the polyester-based material can comprise a polyethylene terephthalate ester-based material, polypropylene terephthalate-based material, polytrimethylene terephthalate ester-based material, polybutylene terephthalate ester-based material, or any combination thereof. In still further aspects as disclosed herein, the polyester-based material can comprise an alkyd resin.

Also disclosed herein is a method making a flooring product comprising: a) providing a primary backing having a face side and a back side and having a plurality of fibers tufted thereinto and extending from the face side to form a face fiber having a predetermined length, and b) disposing a polyester-based material such that it forms a layer disposed at at least a portion of the face fiber.

The details of one or more aspects of the disclosure are set forth in the accompanying drawings and the description below. Other features, objects, and advantages of the disclosure will be apparent from the description and drawings and from the claims.

### BRIEF DESCRIPTION OF THE DRAWINGS

Example features and aspects are disclosed in the accompanying drawings. However, the present disclosure is not limited to the precise arrangements shown, and the drawings are not necessarily drawn to scale.

FIG. 1 illustrates schematics of an exemplary polyester-based material applied as a discontinuous layer, at least partially covering at least a portion of the plurality of fibers in one aspect.

FIG. 2 illustrates schematics of an exemplary polyester-based material applied as a continuous layer, at least partially covering at least a portion of the plurality of fibers in another aspect.

FIG. 3 illustrates a schematics of an exemplary polyester-based material applied as a discontinuous layer covering a full length of the face fiber in one aspect.

FIG. 4 illustrates schematics of an exemplary polyester-based material applied as a continuous layer covering a full length of the face fiber and the face side of the primary backing in another aspect.

FIG. 5 illustrates schematics of an exemplary polyester-based material applied as a discontinuous layer covering a full length of the face fiber with cut loops in one aspect.

FIG. 6 illustrates schematics of an exemplary polyester-based material applied as a continuous layer covering a full length of the face fiber with cut loops and the face side of the primary backing in another aspect.

FIG. 7 illustrates schematics of an exemplary polyester-based material covering a plurality of filaments together in one aspect.

FIG. 8 illustrates schematics of an exemplary polyester-based material covering individual filaments, only those that are situated on the outside in another aspect.

FIG. 9 illustrates schematics of an exemplary polyester-based material covering individual filaments, covering all individual fibers in another aspect.

FIG. 10 illustrates an uncoated PET face fiber after Taber/Velcro testing (FIG. 10A) and coated PET face fiber after Taber/Velcro (FIG. 10B) testing in one aspect.

FIG. 11 illustrates an uncoated PET face fiber after Taber/Velcro testing (FIG. 11A) and coated PET face fiber after Taber/Velcro (FIG. 11B) testing in an additional aspect.

### DETAILED DESCRIPTION

The present invention can be understood more readily by referencing the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein describes particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

The compositions and methods of the appended claims are not limited in scope by the specific compositions and methods described herein, which are intended as illustrations of a few aspects of the claims, and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps are also intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

### Definitions

The term “comprising” and variations thereof as used herein is used synonymously with the term “including” and variations thereof and are open, non-limiting terms. Although the terms “comprising” and “including” have been used herein to describe various aspects, the terms “consisting essentially of” and “consisting of” can be used in place of “comprising” and “including” to provide more specific aspects of the invention and are also described.

As used herein, the singular forms “a,” “an,” and “the” include plural referents unless the context clearly dictates otherwise. Thus, for example, reference to an “article” includes aspects having two or more such articles, or reference to a “product” includes aspects having two or more such products unless the context clearly indicates otherwise.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

For the terms “for example” and “such as,” and grammatical equivalences thereof, the phrase “and without limitation” is understood to follow unless explicitly stated otherwise.

Other than in the examples, or where otherwise noted, all numbers expressing quantities of ingredients, reaction conditions, and so forth used in the specification and claims are to be understood at the very least and not as an attempt to limit the application of the doctrine of equivalents to the scope of the claims, to be construed in light of the number of significant digits and ordinary rounding approaches. Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges and individual numerical values within that range. Thus, for example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

“Optional” and “optionally” means that the subsequently described event or circumstance may or may not occur and that the description includes instances where said event or circumstance occurs and instances where it does not.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.”

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or a section. Thus, a first element, component, region, layer, or section discussed below could be termed a second element, component, region, layer, or section without departing from the teachings of example aspects.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

As used herein, the term “substantially,” in, for example, the context “substantially identical” or “substantially similar” refers to a method or a product, or an article, or a system, or a component that is at least about 90%, at least about 91%, at least about 92%, at least about 93%, at least about 94%, at least about 95%, at least about 96%, at least about 97%, at least about 98%, at least about 99%, or about 100% similar to the method, product, article, system, or the component it is compared to.

As used herein, the term “composition” is intended to encompass a product comprising the specified ingredients in the specified amounts, as well as any product which results, directly or indirectly, from a combination of the specified ingredients in the specified amounts.

A weight percent (wt %) of a component, unless specifically stated to the contrary, is based on the total weight of the formulation or composition in which the component is included.

The term “polymer” may comprise homopolymers, copolymers, such as, for example, block, graft, random, and alternating copolymers, terpolymers, etc., and blends and modifications thereof. Furthermore, unless otherwise specifically limited, the term “polymer” shall include all possible structural isomers; stereoisomers including, without limitation, geometric isomers, optical isomers, or enantiomers; and/or any chiral molecular configuration of such polymer or polymeric material. These configurations include, but are not limited to, isotactic, syndiotactic, and atactic configurations of such polymer or polymeric material. The term “polymer” shall also include polymers made from various catalyst systems, including, without limitation, the Ziegler-Natta catalyst system and the metallocene/single-site catalyst system.

The term “meltspun,” as used herein, may comprise fibers that are formed by extruding molten thermoplastic material as fibers from a plurality of fine, usually circular or trilobal, die capillaries of a spinneret and solidifying the extruded fibers by cooling them as they emerge from the die capillaries.

The term “spunbond,” as used herein, may comprise fibers that are formed by extruding molten thermoplastic material as fibers from a plurality of fine, usually circular or trilobal, capillaries of a spinneret with the diameter of the extruded fibers then being rapidly reduced. According to an embodiment of the invention, spunbond fibers are generally not tacky when they are deposited onto a collecting surface and may be generally continuous.

The term “meltblown,” as used herein, may comprise fibers formed by extruding a molten thermoplastic material through a plurality of fine die capillaries as molten threads or fibers into converging high velocity, usually hot, gas (e.g., air) streams which attenuate the fibers of molten thermoplastic material to reduce their diameter, which may be to microfiber diameter, according to certain aspects of the invention. According to an embodiment of the invention, the die capillaries may be circular. Thereafter, the meltblown fibers are carried by the high-velocity gas stream and are deposited on a collecting surface to form a web of randomly disbursed meltblown fibers. Meltblown fibers are microfibers that may be continuous or discontinuous and are generally tacky when deposited onto a collecting surface.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or description that the steps are to be limited to a specific order, it is in no way intended that an order be inferred in any respect. This holds for any possible non-express basis for interpretation, including matters of logic concerning the arrangement of steps or operational flow, plain meaning derived from grammatical organization or punctuation, or the number or type of aspects described in the specification.

The present invention may be understood more readily by reference to the following detailed description of various aspects of the disclosure and the examples included therein and their previous and following description.

### Flooring Products

The present disclosure is directed to a flooring product comprising: a) a primary backing having a face side and a back side; b) a plurality of fibers tufted into the primary backing and extending from the face side to form a face fiber having a predetermined length; and c) a layer of a polyester-based material disposed at at least a portion of the face fiber.

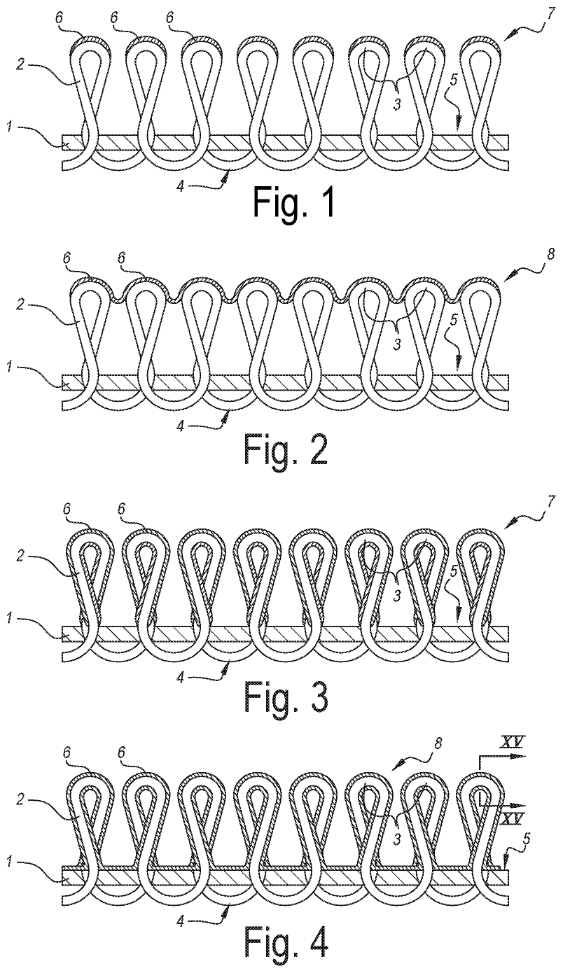

In still further aspects, the layer of the polyester-based material can be present as a continuous layer. While in other aspects, the layer of the polyester-based material can be present as a discontinuous layer. Yet, in other aspects, the layer of the polyester-based material can be present in an intentionally formed pattern and/or unintentionally formed pattern. In still further aspects, the polyester-based material can cover at least some portion of the face fiber. Yet, in other aspects, the polyester-based material can cover substantially the whole length or size of the flooring product. Some exemplary aspects of the present disclosure are shown in the enclosed figures. For example, FIG. 1 shows a disclosed polyester-based material disposed as a discontinued layer at least partially covering the fibers. It can be seen the fibers are incorporated through a primary back 1 to form the face fiber 2 and back side stitches 4. The face fiber shown in FIG. 1 has a closed-loop 3. The polyester-based material 6 in this example covers some portions of the face fiber. The other exemplary aspect is shown in FIG. 2. In this example, the polyester-based material 6 is shown as a continuous film extending through the length of the flooring product. In this particular example, the polyester-based material forms a coating on some portions of the face fibers but does not necessarily fully encapsulate them.

In still further aspects, the layer of the polyester-based material at least partially encapsulates at least a portion of the plurality of fibers. While yet in other aspects, the layer of a polyester-based material substantially encapsulates at least a portion of the plurality of fibers. In still further aspects, the layer of the polyester-based material can encapsulate the whole length of the fiber or at least a portion of it.

In yet other aspects, the layer of the polyester-based material can cover and/or encapsulate at least a portion of the predetermined length of at least a portion of the face fiber. While in still further aspects, the layer of the polyester-based material can cover and/or encapsulate the substantially entire predetermined length of at least a portion of the face fiber.

The exemplary aspects are also shown in FIGS. 3 and 4. For example, in FIG. 3, the polyester-based material 6 is disposed s a discontinuous fiber but fully encapsulates the face fibers 2. In FIG. 4, the polyester-based material continuously encapsulates the face fiber and covers the face side of the primary backing 5. It can be seen that it forms a continuous film 8 (the cross-section of the fibers XV is further shown in FIGS. 7-9).

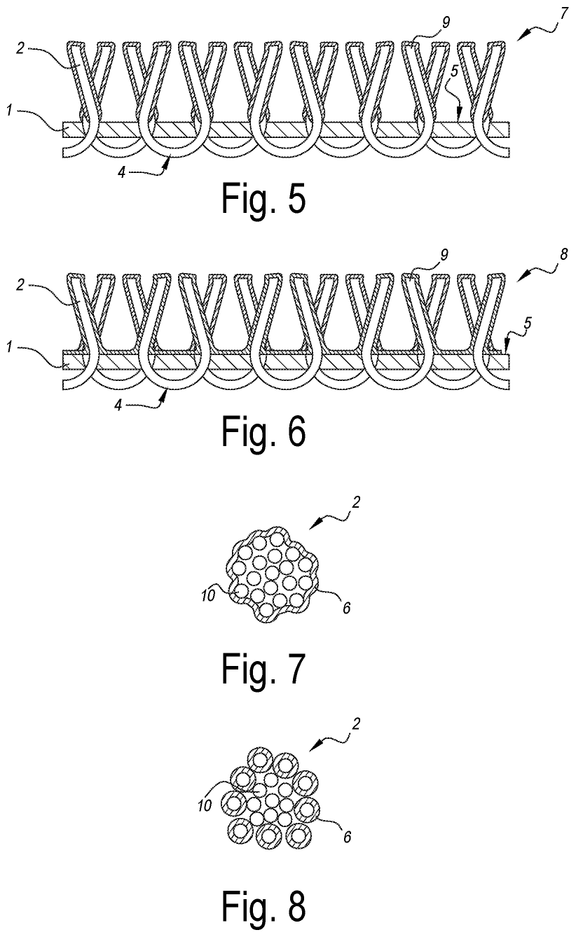

FIGS. 5 and 6 show alternative aspects of continuous and discontinuous layers that fully encapsulate the fiber with cut loops 9.

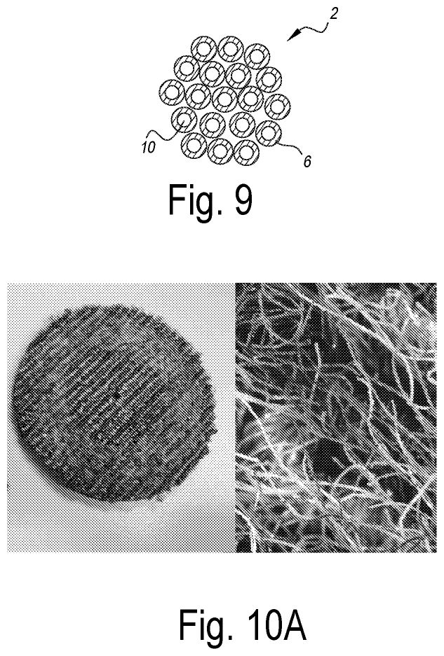

FIG. 7 shows a cross-section of the face fiber where a plurality of filaments are encapsulated in the polyester-based material together. FIG. 8 shows a cross-section where at least a portion of the filaments is encapsulated, where some of the filaments 10 can be free of the polyester-based material. FIG. 9 shows an aspect where all filaments are individually encapsulated with polyester-based material.

In still further aspects, the polyester-based material, as defined herein, can include synthetic polymer whose repeating units contain ester functional groups, wherein these ester functional groups are integral members of the linear polymer chain.

Some typical polyesters, as used in the present disclosure, can be formed by condensation of a dicarboxylic acid and a diol. Representative examples of such dicarboxylic acids include terephthalic acid, isophthalic acid, 2,6-naphthalene dicarboxylic acid, 3,4′-diphenylether dicarboxylic acid, hexahydrophthalic acid, 2,7-naphthalene dicarboxylic acid, phthalic acid, 4,4′-methylenebis(benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediacetic acid, fumaric acid, and maleic acid. Representative examples of such diols include monoethylene glycol, diethylene glycol, triethylene glycol, poly(ethylene ether)glycols, 1,3-propanediol, 1,4-butanediol, poly(butylene ether)glycols, pentamethylene glycol, 1,6-hexanediol, 1,8-octanediol, 1,10-decanediol, 1,12-dodecanediol, 1,14-tetradecanediol, 1,16-hexadecanediol, cis-1,4-cyclohexanedimethanol, and trans-1,4-cyclohexanedimethanol.

In still further aspects, the polyester-based materials can include alkyd resins. It is understood that the alkyd resins are polyesters of polyols and polycarboxylic acids chemically combined with various drying and semi-drying fatty oils in different proportions. Any of the above-disclosed polyols and polycarboxylic acids can be used to form the alkyds of the present disclosure.

In yet further aspects, the polyols can comprise, but are not limited to such components as ethylene glycol, diethylene glycol, neopentyl glycol, 1,4-butanediol, 1,6-hexanediol, glycerol, pentaerythritol, sorbitol and mannitol. In certain aspects, the glycols can comprise ethylene glycol, propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, neopentyl glycol, glycerol, 1,3-propanediol, 2,4-dimethyl-2-ethyl-hexane-1,3-diol, 2,2-dimethyl-1,2-propanediol, 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, 2,2,4-tetramethyl-1,6-hexanediol, thiodiethanol, 1,2-cyclohexanedimethanol, 1,3-cyclohexanedimethanol, 1,4-cyclohexanedimethanol, 2,2,4-trimethyl-1,3-pentanediol, 2,2,4-tetramethyl-1,3-cyclobutanediol, p-xylenediol, hydroxypivalyl hydroxypivalate, 1,10-decanediol, hydrogenated bisphenol A, trimethylolpropane, trimethylolethane, pentaerythritol, erythritol, threitol, dipentaerythritol, sorbitol, mannitol, glycerine, trimellitic anhydride, pyromellitic dianhydride, dimethylolpropionic acid, and the like.

In still further aspects, the polycarboxylic acids can comprise but are not limited to phthalic acid, maleic acid, fumaric acid, isophthalic acid, succinic acid, adipic acid, azelaic acid, and sebacic acid, terephthalic acid, tetrachlorophthalic anhydride, tetrahydrophthalic anhydride, dodecanedioic acid, sebacic acid, azelaic acid, 1,4-cyclohexanedicarboxylic acid, 1,3-cyclohexanedicarboxylic acid, 2,6-naphthalenedicarboxylic acid, glutaric acid, trimellitic anhydride acid, citric acid, pyromellitic dianhydride acid, trimesic acid, sodium sulfoisophthalic acid, as well as from anhydrides of such acids, and esters thereof, where they exist. In still further exemplary and unlimiting aspects, monocarboxylic acids may be employed, including, but not limited to, benzoic acid.

In still further aspects, drying oils can comprise, but are not limited to, coconut oil, fish oil, linseed oil, tung oil, castor oil, cottonseed oil, safflower oil, sunflower oil, soybean oil, and tall oil.

In certain aspects, in addition to an amount of polyol reacted with a fatty acid, fatty ester, or naturally occurring partially saponified oil, an additional amount of a polyol or other branching agent such as a polycarboxylic acid may be used to increase the molecular weight and branching of the alkyd resin, and can be selected from trimethylolethane, pentaerythritol, erythritol, threitol, dipentaerythritol, sorbitol, glycerine, trimellitic anhydride, pyromellitic dianhydride, dimethylolpropionic acid, and trimethylolpropane.

It is further understood that alkyds can be produced by any known-in-the-art processes. For example, alkyds can be produced by direct fusion of glycerol, phthalic anhydride, and drying oil. In certain aspects, and if a reduced viscosity is needed, some additional solvents can be added. Various proportions of the polycarboxylic acid, polyhydric alcohol, and oil are used to obtain alkyd resins of various properties depending on the desired application.

In certain aspects, alkyds can be further modified. For example, alkyds can be urethane modified, acrylic modified, styrene modified, vinyl ester modified, vinyl ether modified, silicone modified, epoxy modified, combinations thereof, and the like.

In certain aspects, the alkyds of the present disclosure can also comprise, for example, uralkyds, i.e., urethane modified alkyds. The exemplary uralkyds can be prepared by reacting alkyds having isocyanate-reactive groups with polyisocyanates, and optionally other components having isocyanate-reactive groups. Isocyanate-reactive groups are defined as groups that will react with an isocyanate group (—NCO), and examples include —OH, —NH2, —NH—, and —SH. Other components can comprise but are not limited to polyamines and polyols, for example, polyols having water-dispersing groups.

Examples of suitable polyisocyanates can comprise diisocyanates. In certain aspects, the polyisocyanates can comprise aliphatic and cycloaliphatic polyisocyanates such as ethylene diisocyanate, 1,6-hexamethylene diisocyanate HDI, isophorone diisocyanate (IPDI), cyclohexane-1,4-diisocyanate, 4,4′-dicyclohexylmethane diisocyanate, cyclopentylene diisocyanate, p-tetra-methylxylene diisocyanate (p-TMXDI) and its meta isomer (m-TMXDI), hydrogenated 2,4-toluene diisocyanate and hydrogenated 2,6-toluene diisocyanate, and the like. In still further aspects, araliphatic and aromatic polyisocyanates can also be utilized. Such exemplary polyisocyanates can include p-xylene diisocyanate, 1,4-phenylene diisocyanate, 2,4-toluene diisocyanate, 2,6-toluene diisocyanate, 4,4′-diphenylmethane diisocyanate, 2,4′-diphenylmethane diisocyanate, and 1,5-naphthalene diisocyanate, their combinations, and admixtures.

Examples of suitable polyols for use in the preparation of uralkyds can comprise difunctional alcohols, trifunctional alcohols (e.g., glycerine, trimethylol propane, trimethylol ethane, trimethylol butane, tris hydroxyethyl isocyanurate, etc.), tetrahydric or higher alcohols (e.g., pentaerythritol, diglycerol, etc.), and combinations thereof. In yet further aspects, trifunctional alcohols can also be used to allow a higher degree of branching. In still further aspects, if difunctional alcohols (or diols) are used, they can also be used in combination with trifunctional or higher alcohols. Examples of suitable diols include neopentyl glycol (NPG), ethylene glycol, propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, 1,3-propanediol, 2,4-dimethyl-2-ethyl-hexane-1,3-diol, 2,2-dimethyl-1,2-propanediol, 2-ethyl-2-butyl-1,3-propanediol, 2-ethyl-2-isobutyl-1,3-propanediol, 1,3-butanediol, 1,4-butanediol, 1,5-pentanediol, 1,6-hexanediol, 2,2,4-tetramethyl-1,6-hexanediol, thiodiethanol, 1,2-cyclohexanedimethanol, 1,3-cyclohexane-dimethanol, 1,4-cyclohexanedimethanol, 2,2,4-trimethyl-1,3-pentanediol, 2,2,4-tetramethyl-1,3-cyclobutanediol, p-xylenediol, hydroxypivalylhydroxypivalate, 1,10-decanediol, and hydrogenated bisphenol-A.

In still further aspects, the reaction mixture for producing alkyds can also include one or more aliphatic or aromatic polycarboxylic acids, esterified polymerization products thereof, and combinations thereof. As used herein, the term “polycarboxylic acid” includes both polycarboxylic acids and anhydrides thereof. Examples of suitable polycarboxylic acids for use in the present invention include phthalic acid, isophthalic acid, terephthalic acid, tetrahydrophthalic acid, naphthalene dicarboxylic acid, and anhydrides and combinations thereof.

Mixtures of polyisocyanates can be used. In yet other aspects, the polyisocyanates can also be modified by introducing urethane, allophanate, urea, biuret, carbodiimide, uretonimine, or isocyanurate residues.

In still further aspects, the polyester-based materials are ammonia-free. In yet further aspects, the polyester-based materials of the present disclosure are alkylphenol ethoxylates (APEOs) free.

In yet still further aspects, the polyester-based materials can form flexible coatings. In yet still, further aspects, the polyester-based materials used to form herein disclosed layers of the polyester-based materials can have a relatively low VOC compared to other coatings known in the art. In such exemplary aspects, an amount of VOCs is less than 50 g/L, less than 40 g/L, less than 30 g/L, less than 20 g/L, less than 10 g/L, less than 1 g/L, or even less than 0.5 g/L.

In still further aspects, the polyester-based material can comprise a polyethylene terephthalate ester-based material, polypropylene terephthalate-based material, polytrimethylene terephthalate ester-based material, polybutylene terephthalate ester-based material, or any combination thereof. In still further aspects, these polyesters can be modified as disclosed above.

In still further aspects, the layer polyester-based materials disclosed herein can comprise a plurality of particles. In still further aspects, the layer of the polyester-based material can comprise solids. In still further aspects, the plurality of particles can have an average particle size from 0.03 to 100 μm, including exemplary values of 0.05 μm, 0.1 μm, 0.5μ, 1 μm, 2μ, 3μ, 4μ, 5μ, 6μ, 7 μm, 8 μm, 9μ, 10μ, 15μ, 20μ, 25 μm, 30 μm, 35 μm, 40 μm, 45 μm, 50 μm, 55 μm, 60 μm, 65 μm, 70 μm, 75 μm, 80 μm, 85 μm, 90 μm, and 95 μm. In yet other aspects, the plurality of particles can have an average particles size greater than 100 μm, greater than 150 μm, greater than 200 μm, or even greater than 300 μm.

In still further aspects, the polyester-based material can be provided as a composition that then is disposed on the flooring product. The composition can be, for example, provided as an aqueous emulsion. Yet, in other aspects, the composition can be provided as a powder that is then emulsified as needed.

In some aspects, the polyester-based material composition used to form the layer of the polyester-based material can have a solid content of 25 to 85 percent by weight, based on the total weight of the composition; including exemplary values of 30 weight percent, 35 weight percent, 40 weight percent, 45 weight percent, 50 weight percent, 55 weight percent, 60 weight percent, 65 weight percent, 70 weight percent, 75 weight percent, and 80 weight percent.

In still further aspects, the composition used to form the polyester-based layer can have pH anywhere between 4 and 11, including exemplary values of 5, 6, 7, 8, 9, and 10. Any values between any two foregoing values can also be observed.

In still further aspects, the composition used to form the polyester-based layer can exhibit a viscosity of from 100 to 10,000 cP measured via Brookfield viscometer, at 20 rpm and 21° C., including exemplary values of 200, 500, 700, 1,000, 2,000, 3,000, 4,000, 5,000, 6,000, 7,000, 8,000, and 9,000 cP.

The composition used to form the polyester-based layer can have a viscosity in the range of from 100 to 1,500,000 Centipoise (mPa·s) at 80° C. and a shear rate of 0.10/sec. All individual values and subranges from 100 to 1,500,000 Centipoise (mPa·s) at 80° C. and shear rate of 0.10/sec are included herein and disclosed herein; for example, the viscosity may be from a lower limit of 100, 1000, 5000, 15000, or 25000 Centipoise (mPa·s) at 80° C. and shear rate of 0.10/sec to an upper limit of 100,000, 250,000, 500,00, 750,000, 1,000,000, or 1,500,000 Centipoise (mPa·s) at 80° C. and shear rate of 0.10/sec.

In still further aspects, the composition can also form a foam. In such aspects, the foam volume can be anywhere between 100 g/L to 1,000 g/L, including exemplary values of 200 g/L, 300 g/L, 400 g/L, 500 g/L, 600 g/L, 700 g/L, 800 g/L, and 900 g/L. In still further aspects, the foam viscosity can be anywhere between 700 cP to 15,000 cP, including exemplary values of 1,000 cP, 2,000 cP, 3,000 cP, 4,000 cP, 5,000 cP, 6,000 cP, 7,000 cP, 8,000 cP, 9,000 cP, 10,000 cP, 11,000 cP, 12,000 cP, 13,000 cP, and 14,000 CP.

Yet, in other aspects, the composition comprises defoamer. In such exemplary aspects, the composition may not form the foam.

The dispersion used to form the polyester-based layer can comprise from 10 to 90 weight percent of the polyester-based material. For example, when the polyester-based dispersion can comprise from 10 to 90 percent by weight of one or more alkyds, including exemplary values of 10, 15, 20, 25, 30, 35, 40, 45, 50, 55, 60, 65, 70, 75, 80, and 85 percent by weight of polyester-based materials. Each of one or more polyester-based materials can have a molecular weight (Mn) in the range of equal to or greater than 1000 Dalton; for example, equal to or greater than 2000 Dalton, equal to or greater than 3000 Dalton, equal to or greater than 4000 Dalton, equal to or greater than 5000 Dalton, equal to or greater than 6000 Dalton, equal to or greater than 7000 Dalton, equal to or greater than 8000 Dalton, equal to or greater than 9000 Dalton, or in the alternative, equal to or greater than 10000 Dalton.

The alkyd resins suitable for the present invention have a viscosity in the range of from 100 to 1,500,000 Centipoise (mPa·s) at 80° C. and a shear rate of 0.10/sec. All individual values and subranges from 100 to 1,500,000 Centipoise (mPa·s) at 80° C. and shear rate of 0.10/sec are included herein and disclosed herein; for example, the viscosity may be from a lower limit of 100, 1000, 5000, 15000, or 25000 Centipoise (mPa·s) at 80° C. and shear rate of 0.10/sec to an upper limit of 100,000, 250,000, 500,00, 750,000, 1,000,000, or 1,500,000 Centipoise (mPa·s) at 80° C. and shear rate of 0.10/sec.

In still further aspects, the composition of the polyester-based material used to form the layer of the polyester-based material (and therefore, the layer itself) can also comprise a fire-resistant material, a stain-resistant material, a soil resistant material, a water-repellant material, a filler, a pigment, an anti-bacterial material, an anti-fungal material, an anti-insect material, an anti-viral material, an odor-resistant material or any combination thereof.

In some aspects, the composition used to form the layer of the polyester-based material can further comprise one or more binder compositions such as acrylic latex, vinyl acrylic latex, styrene acrylic latex, vinyl acetate ethylene latex, and combinations thereof; optionally one or more solvents; optionally one or more co-solvents; optionally one or more fillers; optionally one or more additives; optionally one or more pigments, e.g. titanium dioxide, mica, calcium carbonate, silica, zinc oxide, milled glass, aluminum trihydrate, talc, antimony trioxide, fly ash, and clay; optionally one or more dispersants, e.g. aminoalcohols, and polycarboxylates; optionally one or more surfactants; optionally one or more defoamers; optionally one or more preservatives, e.g. biocides, mildewcides, fungicides, algaecides, and combinations thereof; optionally one or more thickeners, e.g. cellulosic based thickeners such as hydroxyethyl cellulose, hydrophobically modified alkali soluble emulsions and hydrophobically modified ethoxylated urethane thickeners (HEUR); optionally one or more biocides; optionally more defoamers; optionally one or more flow agents; optionally one or more leveling agents; or optionally one or more additional neutralizing agents, e.g. hydroxides, amines, ammonia, and carbonates. In yet other aspects, the composition can also comprise a surfactant. In such aspects, any of the known-in-the-art surfactants suitable for the specific application can be utilized.

In certain aspects, the composition can also comprise a colorant. A variety of colors may be used. Examples include white, black, yellow, magenta, cyan, or any other desired color. Colorants, as used herein, include dyes, pigments, and pre-dispersions, among others. These colorants may be used singly, in a mixture, or as a solid solution. In various embodiments, pigments may be provided in the form of raw pigments, treated pigments, pre-milled pigments, pigment powders, pigment presscakes, pigment masterbatches, recycled pigment, and solid or liquid pigment pre-dispersions. Exemplary colorant particles include, but are not limited to, pigments such as yellow coloring agent, a condensed azo compound, an isoindoline compound, an anthraquinone compound, an azometal complex methine compound, and an allylamide compound as pigments may be used. As a magenta coloring agent, a condensed azo compound, a diketopyrrolopyrrole compound, anthraquinone, a quinacridone compound, a base dye lake compound, a naphthol compound, a benzimidazolone compound, a thioindigo compound, and a perylene compound may be used. As a cyan coloring agent, a copper phthalocyanine compound and its derivative, an anthraquinone compound, a base dye lake compound, and the like may be used.

In still further aspects, the flooring product exhibits an abrasion resistance as measured by Taber Abrasion Test at least 5% higher, at least 10% higher, at least 15% higher, at least 20% higher, at least 25% higher, at least 30% higher, at least 35% higher, at least 40% higher, at least 45% higher, at least 50% higher, at least 55% higher, at least 60% higher, at least 65% higher, at least 70% higher, at least 75% higher, at least 80% higher, at least 85% higher, at least 90% higher, at least 95% higher, or at least 100% higher than an abrasion resistance measured for a substantially identical reference flooring product having a substantially identical composition in the absence of the layer of the polyester-based material. In certain aspects, the Taber Abrasion Testing ASTM D4060 can be used to test the abrasion.

In still further aspects, the flooring product exhibits an abrasion resistance as measured by Hexapod Tumble Abrasion Test at least 5% higher, at least 10% higher, at least 15% higher, at least 20% higher, at least 25% higher, at least 30% higher, at least 35% higher, at least 40% higher, at least 45% higher, at least 50% higher, at least 55% higher, at least 60% higher, at least 65% higher, at least 70% higher, at least 75% higher, at least 80% higher, at least 85% higher, at least 90% higher, at least 95% higher, or at least 100% higher than an abrasion resistance measured for a substantially identical reference flooring product having a substantially identical composition in the absence of the layer of the polyester-based material. In such exemplary aspects, a Hexapod Tumble Drum Tester, according to ASTM D5252, can be utilized.

In still further aspects, the flooring product exhibits a tuft bind as measured by Standard Test Method for Tuft Bind of Pile Yarn Floor coverings according to ASTM D1335-21 test at least 5% higher, at least 10% higher, at least 15% higher, at least 20% higher, at least 25% higher, at least 30% higher, at least 35% higher, at least 40% higher, at least 45% higher, at least 50% higher, at least 55% higher, at least 60% higher, at least 65% higher, at least 70% higher, at least 75% higher, at least 80% higher, at least 85% higher, at least 90% higher, at least 95% higher, or at least 100% higher than a tuft bind measured for a substantially identical reference flooring product having a substantially identical composition in the absence of the layer of the polyester-based material.

In still further aspects, the flooring product exhibits wet delamination as measured according to ASTM D3936 test at least 5% higher, at least 10% higher, at least 15% higher, at least 20% higher, at least 25% higher, at least 30% higher, at least 35% higher, at least 40% higher, at least 45% higher, at least 50% higher, at least 55% higher, at least 60% higher, at least 65% higher, at least 70% higher, at least 75% higher, at least 80% higher, at least 85% higher, at least 90% higher, at least 95% higher, or at least 100% higher than wet delamination measured for a substantially identical reference flooring product having a substantially identical composition in the absence of the layer of the polyester-based material.

In yet still further aspects, the flooring product exhibits a greater impermeability to fluids as measured by Standard Test Methods for Water Vapor Transmission of Materials according to ASTM E96/E96-16 than an impermeability to fluids of a substantially identical reference flooring product having a substantially identical composition in the absence of the layer of the polyester-based material.

In still further aspects, the layer of the polyester-based material is present in an amount of 0.1-10 oz/yd² (3.39-339 g/m²), including exemplary values of 0.2 oz/yd² (6.78 g/m²), 0.3 oz/yd² (10.17 g/m²), 0.4 oz/yd² (13.56 g/m²), 0.5 oz/yd² (16.95 g/m²), 0.6 oz/yd² (20.34 g/m²), 0.7 oz/yd² (23.73 g/m²), 0.8 oz/yd² (27.12 g/m²), 0.9 oz/yd² (30.52 g/m²), 1.0 oz/yd² (33.90 g/m²), 1.1 oz/yd² (37.30 g/m²), 1.2 oz/yd² (40.69 g/m²), 1.3 oz/yd² (44.08 g/m²), 1.4 oz/yd² (47.47 g/m²), 1.5 oz/yd² (50.86 g/m²), 1.6 oz/yd² (54.25 g/m²), 1.7 oz/yd² (57.64 g/m²), 1.8 oz/yd² (61.03 g/m²), 1.9 oz/yd² (64.42 g/m²), 2.0 oz/yd² (67.81 g/m²), 2.1 oz/yd² (71.20 g/m²), 2.2 oz/yd² (74.59 g/m²), 2.3 oz/yd² (77.98 g/m²), 2.4 oz/yd² (81.37 g/m²), 2.5 oz/yd² (84.76 g/m²), 2.6 oz/yd² (88.15 g/m²), 2.7 oz/yd² (91.55 g/m²), 2.8 oz/yd² (94.94 g/m²), 2.9 oz/yd² (98.33 g/m²), 3.0 oz/yd² (101.72 g/m²), 3.1 oz/yd² (105.11 g/m²), 3.2 oz/yd² (108.50 g/m²), 3.3 oz/yd² (111.89 g/m²), 3.4 oz/yd² (115.28 g/m²), 3.5 oz/yd² (118.67 g/m²), 3.6 oz/yd² (122.06 g/m²), 3.7 oz/yd² (125.45 g/m²), 3.8 oz/yd² (128.84 g/m²), 3.9 oz/yd² (132.23 g/m²), 4.0 oz/yd² (135.62 g/m²), 4.1 oz/yd² (139.01 g/m²), 4.2 oz/yd² (142.40 g/m²), 4.3 oz/yd² (145.79 g/m²), 4.4 oz/yd² (149.19 g/m²), 4.5 oz/yd² (152.58 g/m²), 4.6 oz/yd² (155.97 g/m²), 4.7 oz/yd² (159.36 g/m²), 4.8 oz/yd² (162.75 g/m²), 4.9 oz/yd² (166.14 g/m²), 5.0 oz/yd² (169.53 g/m²), 5.1 oz/yd² (172.92 g/m²), 5.2 oz/yd² (176.31 g/m²), 5.3 oz/yd² (179.70 g/m²), 5.4 oz/yd² (183.09 g/m²), 5.5 oz/yd² (186.48 g/m²), 5.6 oz/yd² (189.87 g/m²), 5.7 oz/yd² (193.26 g/m²), 5.8 oz/yd² (196.65 g/m²), 5.9 oz/yd² (200.04 g/m²), 6.0 oz/yd² (203.43 g/m²), 6.1 oz/yd² (206.82 g/m²), 6.2 oz/yd² (210.22 g/m²), 6.3 oz/yd² (213.61 g/m²), 6.4 oz/yd² (217.00 g/m²), 6.5 oz/yd² (220.39 g/m²), 6.6 oz/yd² (223.78 g/m²), 6.7 oz/yd² (227.17 g/m²), 6.8 oz/yd² (230.56 g/m²), 6.9 oz/yd² (233.95 g/m²), 7.0 oz/yd² (237.34 g/m²), 7.1 oz/yd² (240.73 g/m²), 7.2 oz/yd² (244.12 g/m²), 7.3 oz/yd² (247.51 g/m²), 7.4 oz/yd² (250.90 g/m²), 7.5 oz/yd² (254.29 g/m²), 7.6 oz/yd² (257.68 g/m²), 7.7 oz/yd² (261.07 g/m²), 7.8 oz/yd² (264.46 g/m²), 7.9 oz/yd² (267.86 g/m²), 8.0 oz/yd² (271.25 g/m²), 8.1 oz/yd² (274.64 g/m²), 8.2 oz/yd² (278.03 g/m²), 8.3 oz/yd² (281.42 g/m²), 8.4 oz/yd² (284.81 g/m²), 8.5 oz/yd² (288.20 g/m²), 8.6 oz/yd² (291.59 g/m²), 8.7 oz/yd² (294.98 g/m²), 8.8 oz/yd² (298.37 g/m²), 8.9 oz/yd² (301.76 g/m²), 9.0 oz/yd² (305.15 g/m²), 9.1 oz/yd² (308.54 g/m²), 9.2 oz/yd² (311.93 g/m²), 9.3 oz/yd² (315.32 g/m²), 9.4 oz/yd² (318.71 g/m²), 9.5 oz/yd² (322.10 g/m²), 9.6 oz/yd² (325.49 g/m²), 9.7 oz/yd² (328.89 g/m²), 9.8 oz/yd² (332.28 g/m²), and 9.9 oz/yd² (335.67 g/m²).

In still further aspects, the plurality of fibers comprise polyamide, polyester, polyolefin, natural fibers, or any combination thereof.

In aspects where the plurality of fibers comprise the polyamide, the polyamide can be formed by condensation polymerization of a dicarboxylic acid and a diamine. Representative examples of such dicarboxylic acids include terephthalic acid, isophthalic acid, 2,6-naphthalene dicarboxylic acid, 3,4′-diphenylether dicarboxylic acid, hexahydrophthalic acid, 2,7-naphthalenedicarboxylic acid, phthalic acid, 4,4′-methylenebis(benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediactic acid, fumaric acid, and maleic acid. Representative examples of such diamines include ethylene diamine, tetramethylene diamine, hexamethylene diamine, 1,9-nonanediamine, 2-methyl pentamethylene diamine, trimethyl hexamethylene diamine (TMD), m-xylylene diamine (MXD), and 1,5-pentanediamine.

In some aspects, the polyamide can be formed by condensation polymerization of an amino acid (such as 11-aminoundecanoic acid) or ring-opening polymerization of a lactam (such as caprolactam or @-aminolauric acid).

In certain aspects, when the plurality of fibers comprise a polyamide, the polyamide can include, but not limited to, polyamide 6, polyamide 11, polyamide 12, polyamide 46, polyamide 410, polyamide 4T, polyamide 56, polyamide 510, polyamide D6, polyamide DT, polyamide DI, polyamide 66, polyamide 610, polyamide 611, polyamide 612, polyamide 6T, polyamide 6I, polyamide MXD6, polyamide 9T, polyamide 1010, polyamide 10T, polyamide 1212, polyamide 12T, polyamide PACM12, and polyamide TMDT, polyamide 611, and polyamide 1012; polyphthalimides such as polyamide 6T/66, polyamide LT/DT, and polyamide L6T/6I; and aramid polymers. In still further aspects, the polyamide can comprise a polyamide copolymer, for example but not limited to a polyamide 6/polyamide 66 copolymer, polyamide 6/polyamide 6T copolymer, polyamide 6I/polyamide6T copolymer, polyamide 66/polyamide 6T copolymer, or polyamide 12/polyamide MAMCI copolymer.

In yet other aspects, the plurality of fibers can comprise nylon 6, nylon 66, nylon 666, nylon 610, nylon 512, nylon 11, or nylon 12, or a combination thereof.

In other aspects, the plurality of fibers can comprise a polyolefin. In such aspects, the polyolefin can comprise polyethylene, polypropylene, or a combination thereof.

In aspects where the plurality of fibers comprise a polyester, such a polyester can be formed by condensation of a dicarboxylic acid and a diol. Representative examples of such dicarboxylic acids include terephthalic acid, isophthalic acid, 2,6-naphthalene dicarboxylic acid, 3,4′-diphenylether dicarboxylic acid, hexahydrophthalic acid, 2,7-naphthalene dicarboxylic acid, phthalic acid, 4,4′-methylenebis(benzoic acid), oxalic acid, malonic acid, succinic acid, methyl succinic acid, glutaric acid, adipic acid, 3-methyladipic acid, pimelic acid, suberic acid, azelaic acid, sebacic acid, 1,11-undecanedicarboxylic acid, 1,10-dodecanedicarboxylic acid, 1,12-dodecanedicarboxylic acid, hexadecanedioic acid, docosanedioic acid, tetracosanedioic acid, 1,4-cyclohexanedicarboxylic acid, 1,3-cyclohexanedicarboxylic acid, 1,2-cyclohexanediacetic acid, fumaric acid, and maleic acid. Representative examples of such diols include monoethylene glycol, diethylene glycol, triethylene glycol, poly(ethylene ether)glycols, 1,3-propanediol, 1,4-butanediol, poly(butylene ether)glycols, pentamethylene glycol, 1,6-hexanediol, 1,8-octanediol, 1,10-decanediol, 1,12-dodecanediol, 1,14-tetradecanediol, 1,16-hexadecanediol, cis-1,4-cyclohexanedimethanol, and trans-1,4-cyclohexanedimethanol.

In still further aspects, the polyester can comprise polyethylene terephthalate ester, polypropylene terephthalate, polytrimethylene terephthalate ester, polybutylene terephthalate ester, or any combination thereof. It is understood that the mentioned herein polyesters comprise both homopolymers and copolymers. For example, when the polyethylene terephthalate ester is discussed, it can include homopolymers of the polyethylene terephthalate ester and copolymers of the polyethylene terephthalate ester. Similarly, when the polybutylene terephthalate ester is discussed, it can include homopolymers and copolymers of the polybutylene terephthalate ester and the like. In still further aspects, the plurality of fibers can comprise polyethylene terephthalate (PET), polytrimethylene terephthalate (PTT), or combinations thereof. In some other aspects, the exemplary polyesters can include poly(ethylene terephthalate) (PET), poly(trimethylene terephthalate) (PTT), poly(butylene terephthalate) (PBT), poly(ethylene isophthalate), poly(octamethylene terephthalate), poly(decamethylene terephthalate), poly(pentamethylene isophthalate), poly(butylene isophthalate), poly(hexamethylene isophthalate), poly(hexamethylene adipate), poly(pentamethylene adipate), poly(pentamethylene sebacate), poly(hexamethylene sebacate), poly(1,4-cyclohexylene terephthalate), poly(1,4-cyclohexylene sebacate), poly(ethylene terephthalate-co-sebacate), and poly(ethylene-co-tetramethylene terephthalate).

In yet in other aspects, the plurality of fibers can comprise a combination of polyamides, polyolefins, and polyesters.

In still further aspects, the fibers can also comprise additional additives such as fillers, flame retardants, reinforcing agents, thermal stabilizers, ultraviolet light stabilizers, hindered amine stabilizers, impact modifiers, flow enhancing additives, stabilizing agents, delustering agents, porosity additives, leveling agents, and the like, and any combination thereof. In some aspects, the flame retardant additives can comprise, for example, decabromodiphenyl ether and triaryl phosphates such as triphenyl phosphate and the like. In other aspects, the thermal stabilizers can comprise, for example, thermal conductivity improvers such as zinc oxide and titanium oxide. In other aspects, ultraviolet light stabilizers can comprise resorcinol monobenzoates, phenyl salicylate and 2-hydroxybenzophenones, and the like. In other aspects, hindered amine stabilizers can comprise benzotriazole, benzophenone, oxalanilide, and cerium oxide, and the like. In yet further aspects, fibers can further comprise ionomers, liquid crystal polymers; fluoropolymers; olefins including cyclic olefins; polyamides; ethylene-vinyl acetate copolymers; stabilizing agents such as ortho-phosphoric acid, triphenylphosphate, and triethylphosphino acetate. In still further aspects, the delustering agents can comprise titanium oxide. While in other aspects, the fibers can also comprise carriers such as o-phenylphenol, p-phenylphenol, o-dichlorobenzene, trichlorobenzene, monochlorobenzene, biphenyl, methyl salicylate, butyl benzoate, benzyl benzoate, benzoic acid, benzalacetone, and methyl cinnamate. In yet still further aspects, the fiber can comprise leveling agents such as bishydroxymethyloxazoline, diaryl ethers, ditolyl ether, sodium di-naphthylmethane-B,B-disulfonate, ammonium dodecylbenzene sulfonate, sodium tetrapropylbenzene sulfonate, homopolymers or oligomers of N-vinylpyrrolidone and poly(tetrahydrofuran). While in still further aspects, the fibers can comprise porosity additives such as metal oxalate complexes, organic sulfonate salts, jade powder, and zeolite powder, and the like.

In still further aspects, at least a portion of the plurality of fibers can comprise a bicomponent fiber. As used herein, the term “bicomponent fibers” are fibers that are formed by extrusion spinning. In such aspects, fibers can have two components extruded from separate extruders but spun together to form one fiber. Bicomponent fibers are also sometimes referred to as conjugate fibers or multi-component fibers. In certain aspects, the first and the second polymers used to form the first and the second component of the bicomponent fiber can be the same or different. In certain aspects, the same polymer is used to form the first and the second components to create the desired gradient of the plurality of solid particles between the surface of the fiber and the bulk of the fiber while keeping the same polymer composition of the fiber. However, in other aspects, the first polymer and the second polymers can be different depending on the desired application.

The first and the second polymers, either the same or different, of the bicomponent fibers can be arranged in a substantially constant position in distinct zones across the cross-section of the bicomponent fibers and extend continuously along the length of the bicomponent fibers. The configuration of such a bicomponent fiber can be, for example, a sheath/core arrangement wherein one polymer is surrounded by another, or can be a side-by-side arrangement, a homo-homo arrangement, a pie arrangement, or an “islands-in-the-sea” arrangement, each as is known in the art of multi-component, including bicomponent, fibers. In yet other aspects, the bicomponent fiber can have a core/sheath configuration. In some aspects, for example, where the first polymer and the second polymer are not the same, a core fiber can be made from the second polymer encased within a thermoplastic sheath made from the first polymer or have a side-by-side arrangement of different thermoplastic fibers. In such exemplary and unlimiting aspects, the first and the second polymers can melt at different temperatures. In the exemplary sheath/core arrangement, these bicomponent fibers can provide thermal bonding due to the melting of the sheath polymer while retaining the desirable strength characteristics of the core polymer. Any of the disclosed above polymers can be used as a first and/or second polymer to form a bicomponent fiber.

In yet other aspects an as discussed above, the fibers of the current disclosure can include more than two components and/or have any radial cross-sectional shape, including any of the shapes described herein.

In still further aspects, the fibers disclosed herein can be staple fibers, bulk continuous filament, or any combination thereof.

In still further aspects, the plurality of fibers can form a yarn. In some aspects, the yarn is monofilament. In yet other aspects, the yarn is multifilament. For example, a plurality of any of the disclosed herein fibers can be combined into a yarn.

In still further aspects, the yarn can be fully-drawn yarn, spin-drawn yarn, low- or not-twisted yarn, twisted yarn, a flat yarn, a textured yarn, a high (HS) stretch textured yarn, a high-bulk textured yarn, or any combination thereof.

In still further aspects, the primary backing of the disclosed herein flooring product can also comprise a polyolefin, a polyamide, a polyester, or a combination thereof.

In still further aspects, the primary backing can comprise a polyamide comprising nylon 6, nylon 66, nylon 666, nylon 610, nylon 512, nylon 11, or nylon 12, or a combination thereof. While in other aspects, the primary backing can comprise a polyester comprising polyethylene terephthalate ester, polypropylene terephthalate, polytrimethylene terephthalate ester, polybutylene terephthalate ester, or any combination thereof. While still in further aspects, the primary backing can comprise a polyolefin comprising a polyolefin, and the polyolefin comprises polyethylene, polypropylene, or a combination thereof.

In certain aspects, the primary backing can be woven or nonwoven. In some aspects, the primary backing comprises polyethylene, polypropylene, or a combination thereof. In other aspects, the primary backing can be a polyester primary backing. In such aspects, the primary backing can include polyethylene terephthalate (PET), polytrimethylene terephthalate (PTT), or a combination thereof.

Yet in other aspects, the primary backing can comprise polyester or polyamide and can include less than 10 wt % of a polyolefin, less than 9 wt % of a polyolefin, less than 8 wt % of a polyolefin, less than 7 wt % of a polyolefin, less than 6 wt % of a polyolefin, less than 5 wt % of a polyolefin, less than 4 wt % of a polyolefin, less than 3 wt % of a polyolefin, less than 2 wt % of a polyolefin, or less than 1 wt % of a polyolefin. In certain aspects, for example, the primary backing can include about 5% of a polyolefin. In such exemplary aspects when the polyolefin is present, the polyolefin can have a melting point from 105° C. to 180° C., including exemplary values of 110° C., 115° C., 120° C., 125° C., 130° C., 135° C., 140° C., 145° C., 150° C., 155° C., 160° C., 165° C., 170° C., and 175° C. In still further aspects, for instance, the polyolefin can have a melting point of at least 150° C. In certain exemplary and unlimiting aspects, the polyolefin can include polyethylene (e.g., an ethylene copolyester). Without intending to be limited by any theory, the addition of the polyolefin can improve the tenacity of the primary backing for processing while only slightly decreasing the strength and dimensional stability of the final flooring product.

In further aspects, for example, the primary backing can also comprise a copolyester to improve tenacity.

As further noted above, the primary backing can be a woven fabric backing. In some embodiments, for example, the primary backing can comprise a slit tape. However, it is understood that the primary woven fabric backings are not limited to the slit tape and can instead comprise round, trilobal, or rectangular filaments as understood by one of ordinary skill in the art. In certain aspects, in the weft direction, the woven primary backing may comprise a slit tape at 11-20 picks per inch, including exemplary values of 12, 13, 14, 15, 16, 17, 18, and 19 picks per inch, 95-millimeter width, and 800-1,050 denier, including exemplary values of 850 deniers, 900 deniers, 950 deniers, and 1,000 deniers. In the warp direction, the woven primary backing can comprise slit tape at 20-31 ends per inch, including exemplary values of 21, 22, 23, 24, 25, 26, 27, 28, 29, and 30 ends per inch, 45-millimeter width, and 400-500 denier, including exemplary values of 410, 420, 430, 440, 450, 460, 470, 480, and 490 denier. An example of a suitable woven primary backing is the 18 pick Artis® from Propex, 4019 Industry Drive, Chattanooga, TN.

In still further aspects, and as disclosed above, the primary backing can be a nonwoven primary backing. In such exemplary aspects, the nonwoven fabric primary backing comprises a spunbond, meltblown, or meltspun fabric. In some aspects, for example, the nonwoven primary backing can comprise an 80-150 g/m², including exemplary values of 90, 100, 110, 120, 130, and 140 g/m² spunbond. In other exemplary aspects, the nonwoven primary backing can be bonded and entangled via hydroentangling or needling before tufting. In further exemplary aspects, the nonwoven fabric backing can comprise up to 1 wt %, up to 5 wt %, up to 7 wt %, up to 10 wt %, up to 12 wt %, up to 15 wt %, up to 17 wt %, and 20 wt % of a low melt copolyester (e.g., coPET) or a low melt copolymer of a polyamide polymer based on the total weight of primary backing.

In still further exemplary and non-limiting aspects, the nonwoven primary backing can comprise a plurality of PET filaments and a plurality of coPET filaments randomly interspersed among the plurality of polyester filaments. This random interspersion can be achieved via, for example, a spunbonding or meltblowing process. In other aspects, the coPET filaments can be distributed evenly and/or according to a pattern as understood by one of ordinary skill in the art. In still further aspects, the nonwoven primary backing can comprise all or a portion of bicomponent fibers having a core formed at least in part by PET and a low melt sheath formed at least in part by coPET. In yet other aspects, for instance, the nonwoven primary backing can comprise bicomponent fibers having a side-by-side arrangement of PET and coPET.

In certain aspects, the disclosed herein flooring products can have a weight of the primary backing of 2-6 oz/yd² (67.81-203.43 g/m²), including exemplary values of 2.5 oz/yd² (84.76 g/m²), 3 oz/yd² (101.72 g/m²), 3.5 oz/yd² (118.67 g/m²), 4 oz/yd² (135.62 g/m²), 4.5 oz/yd² (152.58 g/m²), 5 oz/yd² (169.63 g/m²), and 5.5 oz/yd² (186.48 g/m²). In still further aspects, the disclosed herein flooring products can have a weight of the primary backing of 2-4 oz/yd² (67.81-135.62 g/m²). Such weights may also improve tear resistance, tensile strength, and tuft bind strength. However, while going beyond these weights can further improve tear resistance, tensile strength, and tuft bind strength, the primary backing can also become uneconomical as too much raw material is required to make a saleable product.

In still further aspects, the flooring material can comprise a precoat material disposed on the backside of the primary backing. It is understood that the precoat material can comprise any known-in-the-art adhesive materials that can provide the desired results.

In some aspects, the precoat layer can comprise any known-in-the-art latexes. For example, and without limitations, the latex can comprise a carboxylated styrene-butadiene (XSB) latex copolymer, a styrene-butadiene resin (SBR) latex, a butadiene-methyl methacrylate (BDMMA) latex, a styrene-acrylic latex, a pure acrylic latex, or any combination thereof.

Yet, in other exemplary and unlimiting aspects, the precoat layer can comprise other adhesives. For example, the precoat layer can be glue. For instance, in some aspects, the precoat layer can be a liquid glue comprising, for example, a copolymer of polyethylene terephthalate (coPET) or copolymer of polytrimethylene terephthalate (coPTT). Yet, in other aspects, the precoat layer can comprise a liquid hot melt adhesive, e.g., molten CoPET. In some aspects, the precoat layer can include a liquid hot-melt adhesive. In such exemplary aspects, the liquid hot melt adhesive can comprise a copolymer of one or more polyamide polymers discussed above. In yet other aspects, the liquid hot melt adhesive can comprise a copolymer of a polyolefin, e.g., polypropylene (PP).

In aspects where the liquid hot melt adhesives are used, such adhesives can have a melting temperature from 130° C. to 200° C., including exemplary values of 140° C., 150° C., 160° C., 170° C., 180° C., and 190° C.

In some aspects, the precoat can have a weight of 3-16 oz/yd² (101.72-542.49 g/m²), including exemplary values of 4 oz/yd² (101.72 g/m²), 4.5 oz/yd² (152.58 g/m²), 5 oz/yd² (169.53 g/m²), 5.5 oz/yd² (1286.48 g/m²), 6 oz/yd² (203.43 g/m²), 6.5 oz/yd² (220.39 g/m²), 7 oz/yd² (237.34 g/m²), 7.5 oz/yd² (254.29 g/m²), 8 oz/yd² (271.25 g/m²), 8.5 oz/yd² (288.20 g/m²), 9 oz/yd² (305.15 g/m²), 9.5 oz/yd² (322.10 g/m²), 10 oz/yd² (339.06 g/m²), 10.5 oz/yd² (356.01 g/m²), 11 oz/yd² (372.96 g/m²), 11.5 oz/yd² (389.92 g/m²), 12 oz/yd² (406.87 g/m²), 12.5 oz/yd² (423.82 g/m²), 13 oz/yd² (440.77 g/m²), 13.5 oz/yd² (457.73 g/m²), 14 oz/yd² (474.68 g/m²), 14.5 oz/yd² (491.63 g/m²), and 15 oz/yd² (508.59 g/m²).

In still further aspects, the precoat material can comprise a material substantially identical to the polyester-based material.

In still further aspects, if needed, the precoat composition can further comprise flame retardants, fillers, tackifiers, dispersing agents, and the like.

In certain aspects, the flooring products disclosed herein are a unitary construction entirely made of substantially like or similar materials. In such exemplary aspects, the plurality of fibers and the primary backing can comprise substantially the same composition. In still further aspects, these flooring products can be substantially fully recyclable.

In some exemplary aspects, the flooring product can include a polyester primary backing with a plurality of polyester fibers tufted therethrough. Even further, such construction can also include liquid hot melt adhesive that is a copolymer of polyethylene terephthalate (CoPET). While in other exemplary aspects, the flooring products can include a polyamide fabric backing with a plurality of polyamide fibers tufted therethrough. Still further, such an exemplary construction can also include a liquid adhesive that is a copolymer of one of the polyamide polymers.

Likewise, the flooring product described herein can include a polypropylene (PP) primary backing with a plurality of polypropylene (PP) fibers tufted therethrough. In yet still further aspects, this exemplary flooring product can further include a liquid adhesive that is a copolymer of polypropylene (PP).

In aspects where the flooring product has a unitary construction, the precoat layer can be a copolymer of the material forming the plurality of fibers, and the primary backing ensures that the precoat layer has a lower melting point than the fibers or the backing.

In other aspects, the flooring product can include a polyester backing with polyamide fibers tufted therethrough and any of the disclosed herein precoat layers anchoring these polyamide fibers to the polyester backing. In another example, the flooring product can include a polyamide backing with polypropylene (PP) fibers tufted therethrough and any of the disclosed herein precoat layers. It shall be understood that the construction of the flooring products is not restricted to the above combinations and can include any combinations of the disclosed materials herein.

In still further aspects, the flooring product can be recyclable when each of the face fiber and the primary backing comprises the polyester.

In some aspects, the flooring product can further comprise a secondary backing. The secondary backing can be laminated to the primary backing to give the flooring product dimensional stability and/or comfort. For example, in some aspects, the secondary backing can be foamed. While in other aspects, the secondary backing can be rigid. In some aspects, the secondary backing can comprise polypropylene; however other backing types, such as jute, polyamide, PVC (polyvinyl chloride), polyurethane, PET, polytrimethylene terephthalate (PTT), or any combination thereof can be used.

In certain aspects, the secondary backing can comprise nonwoven fabrics and can include, but are not limited to, spun-bond, wet-laid, melt-blown, and air-entangled fabrics. In some exemplary aspects, the nonwoven secondary backing may comprise a 60-120 g/m² spunbond.

In yet other aspects, the secondary backing can comprise woven fabrics. In aspects in which a woven secondary backing is used, for example, the woven secondary backing may comprise 5-12 picks per inch and a weight of 2-8 oz/yd² (67.81-271.25 g/m²). For example, in some embodiments, the secondary backing can have a weight of 2-5 oz/yd² (67.81-169.53 g/m²). In other aspects, the secondary backing can have a weight of 3 oz/yd² (101.72 g/m²). In further embodiments, for instance, the secondary backing can comprise a carded and/or needled pad having a weight of 5-35 oz/yd² (101.72-1186.70 g/m²).

In still further aspects, when the secondary backing is present, the flooring product can comprise a delamination strength of greater than 2.5 lb/inch (437.8 Newtons/meter). As above with the primary backings going beyond the weights discussed herein can further improve tear resistance, tensile strength, and tuft bind strength, but the secondary backing can become uneconomical as too much raw material is required to make a saleable product.

In still further aspects, the flooring product can include a reinforcing layer. In such exemplary aspects, the reinforcing layer or a scrim can be positioned between the precoat (or any additional adhesive if disposed on the precoat) and the secondary backing. In such exemplary aspects, the scrim reinforcing layer can comprise fiberglass, a nonwoven fabric, or woven fabric.

In still further aspects, the flooring product comprises a carpet tile, a broadloom carpet, an area rug, a woven rug, or a turf. In yet other aspects, the flooring product can be a rubber mat with face fiber.

### Methods

In still further aspects, disclosed herein are methods of forming any of the described above flooring products. In such aspects, the methods comprise providing a) a primary backing having a face side and a back side and having a plurality of fibers tufted thereinto and extending from the face side to form a face fiber having a predetermined length, and b) disposing a polyester-based material such that it forms a layer disposed at at least a portion of the face fiber.

In certain aspects, the step of disposing comprises disposing an aqueous dispersion comprising the polyester-based material on at least a portion of the face fiber. Yet, in other aspects, in the step of disposing, the polyester-based material at least partially encapsulates at least a portion of the plurality of fibers. In yet still further aspects, in the step of disposing, the polyester-based material substantially encapsulates at least a portion of the plurality of fibers.

In still further aspects, the dispersion can comprise any of the disclosed above polyester-based materials. In yet still further aspects, the dispersion can have any of the disclosed above chemical and physical properties as it relates to the specific compositions, weight percentages, viscosities, and the like.

In still further aspects, the step of disposing can comprise spraying, exhausting, brushing, rolling, doctor blading, casting, spinning, or any combination thereof.

In still further aspects, the methods can comprise drying the flooring product to remove water content and thereby forming the layer comprising the polyester-based material.

In still further aspects, the face fiber and primary backing can be any face fiber and/or primary backing as described above.

In still further aspects, the methods comprise applying a precoat on the backside of the flooring product. It is understood that the precoat material can comprise any of the precoat materials disclosed above.

In some aspects, the precoat is applied before the step of disposing the polyester-based material or after disposing the polyester-based material. While in other aspects, the step of disposing the polyester-based material comprises first applying a precoat layer at the backside, wherein the precoat layer comprises the polyester-based material and then applying pressure such that the polyester-based material penetrates the primary backing and forms the layer disposed at the at least a portion of the face fiber. In such exemplary and unlimiting aspects, the pressure is from 10 to 50 lb-force (44.5-222.4 Newtons), including exemplary values of 15 lb-force (66.7 Newtons), 20 lb-force (89.0 Newtons), 25 lb-force (111.2 Newtons), 30 lb-force (133.4 Newtons), 35 lb-force (155.7 Newtons), 40 lb-force (177.9 Newtons), and 45 lb-force (200.1 Newtons).

It is understood that the plurality of fibers disclosed herein can be formed by any known-in-the-art methods. For example, and without limitations, the fibers can be meltblown, spunbond, or meltspun.

In still further aspects, also disclosed herein are methods of making described above yarns. In such aspects, the methods can comprise steps of blending, carding, drawing out, twisting, spinning, or any combination thereof of the disclosed above fibers.

A number of aspects of the disclosure have been described. Nevertheless, it will be understood that various modifications may be made without departing from the spirit and scope of the invention. Accordingly, other aspects are within the scope of the following claims.

### Examples

In this example, an Uradil™ has been used as a dispersion to form a polyester-based layer.

The layer has been formed by spraying in increments of 25% dilution as topical. For example, 25% Uradil 75% water by weight. Up to 100% Uradil was trialed. All samples ranged from 0.65-3.183 solid oz/yd² (22.04-107.92 g/m²). Before applications, all samples are stored in a climate-controlled environment for 48 hours.

All samples dried for 10 minutes in a 220° F. (104.4° C.) lab oven. Final sample weighed after 24 hours in climate-controlled conditions.

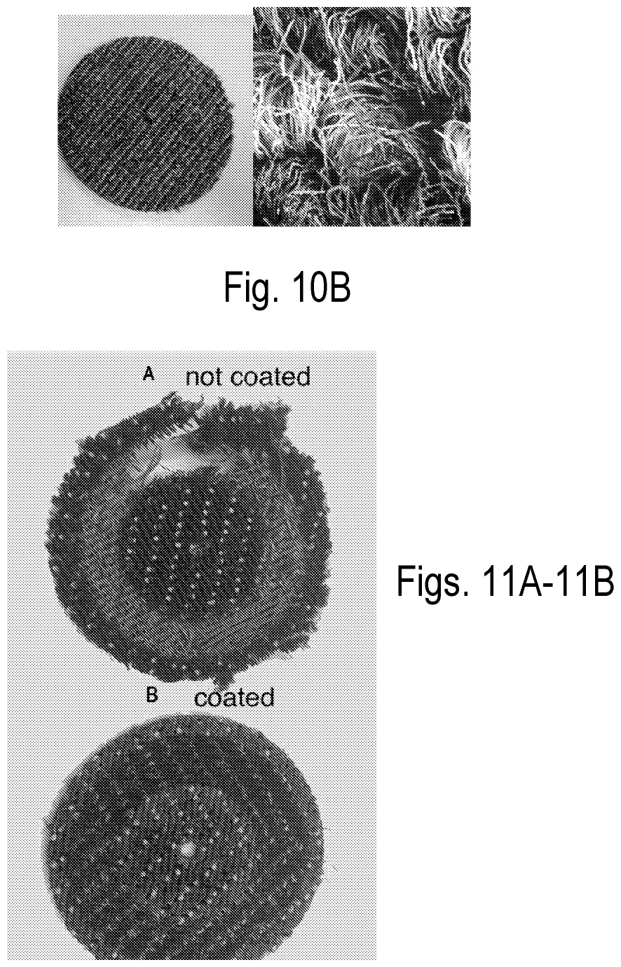

FIGS. 10A-10B show results obtained after Taber/Velcro abrasion tests. 100% PET carpet without any polyester-based material layer has shown a rating of 1 on the Velcro scale (FIG. 10A). While when Uradil was applied at 50% concentration and at 1.79 solid oz/yd² (60.69 g/m²) after 100 cycles, the sample was rated at 3.5 on the Velcro scale, showing high abrasion resistance. The same experiment has been repeated, and results are shown in FIGS. 11A-11B.

1-71. (canceled)

72. A flooring product comprising:
a) a primary backing having a face side and a back side;
b) a plurality of fibers tufted into the primary backing and extending from the face side to form a face fiber having a predetermined length,
c) a secondary backing secured to the back side of the primary backing, and
d) a layer of a polyester-based material disposed at at least a portion of the face fiber, and;
wherein the flooring product exhibits a wet delamination strength as according to ASTM D3936 test of at least 5% higher than wet delamination measured for a substantially identical reference flooring product having a substantially identical composition in the absence of the layer of the polyester-based material.

73. The flooring product of claim 72, further comprising a precoat material disposed on the backside of the primary backing.

74. The flooring product of claim 73, wherein the precoat material is selected from the group consisting of a latex, a liquid hot melt adhesive, a liquid glue, or any combination thereof.

75. The flooring product of claim 74, wherein the precoat material comprises a material substantially identical to the polyester-based material.

76. The flooring product of claim 75, wherein the layer of the polyester-based material is present as a continuous film.

77. The flooring product of claim 75, wherein the layer of the polyester-based material is present as a discontinuous film.

78. The flooring product of claim 76, wherein the layer of a polyester-based material at least partially encapsulates at least a portion of the plurality of fibers.

79. The flooring product of claim 76, wherein the layer of a polyester-based material substantially encapsulates at least a portion of the plurality of fibers.

80. The flooring product of claim 79, wherein the polyester-based material comprises a polyethylene terephthalate ester-based material, polypropylene terephthalate-based material, polytrimethylene terephthalate ester-based material, polybutylene terephthalate ester-based material, or any combination thereof.

81. The flooring product of claim 80, wherein the polyester-based material comprises an alkyd resin.

82. The flooring product of claim 81, wherein the alkyd resin is urethane modified, acrylic modified, styrene modified, vinyl ester modified, vinyl ether modified, silicone modified, epoxy modified, or combinations thereof.

83. The flooring product of claim 82, wherein the flooring product exhibits an abrasion resistance as measured by Taber Abrasion Testing ASTM D4060 at least 5% higher than an abrasion resistance measured for a substantially identical reference flooring product having a substantially identical composition in the absence of the layer of the polyester-based material.

84. The flooring product of claim 82, wherein the flooring product exhibits a tuft bind as measured according to ASTM D1335-21 test at least 5% higher than a tuft bind measured for a substantially identical reference flooring product having a substantially identical composition in the absence of the layer of the polyester-based material.

85. The flooring product of claim 82, wherein the flooring product exhibits a greater impermeability to fluids as measured according to ASTM E96/E96-16 as compared to an impermeability to fluids of a substantially identical reference flooring product having a substantially identical composition in the absence of the layer of the polyester-based material.

86. The flooring product of claim 82, wherein the layer of the polyester-based material is present in an amount of 0.1-10 oz/yd² (3.39-339.06 g/m²).

87. A method of making a flooring product comprising:
providing a griege product comprising:
a) a primary backing having a face side and a back side and having a plurality of fibers tufted thereinto and extending from the face side to form a face fiber having a predetermined length;
b) a secondary backing adhered to the back side of the primary backing;
disposing a polyester-based material onto the face fiber of the griege product such that it forms a layer disposed at at least a portion of the face fiber on the face side of the primary backing; and
wherein the flooring product exhibits a wet delamination strength as measured according to ASTM D3936 test of at least 5% higher than wet delamination measured for a substantially identical reference flooring product having a substantially identical composition in the absence of the layer of the polyester-based material.

88. The method of claim 87, wherein the polyester-based material comprises and aqueous dispersion, wherein the aqueous dispersion further comprises one or more of a fire-resistant material, a stain-resistant material, a soil resistant material, a water-repellant material, a filler, a pigment, an anti-bacterial material, an anti-fungal material, an anti-insect material, an anti-viral material, an odor-resistant material, or any combination thereof.

89. The method of claim 88, wherein the flooring product exhibits an abrasion resistance as measured by Taber Abrasion Testing ASTM D4060 at least 5% higher than an abrasion resistance measured for a substantially identical reference flooring product having a substantially identical composition in the absence of the layer of the polyester-based material.

90. The method of claim 89, wherein the flooring product exhibits a tuft bind as measured according to ASTM D1335-21 test at least 5% higher than a tuft bind measured for a substantially identical reference flooring product having a substantially identical composition in the absence of the layer of the polyester-based material.
